(19) United States
(12) Patent Application Publication
(10) Pub. No.: US 2005/0246119 A1
(43) Pub. Date: Nov. 3, 2005

(54) Event occurrence graph

(76) Inventor: Anurag T. Koodali, Bangalore (IN)

Correspondence Address: TEKTRONIX, INC., M/S 50-LAW, P.O. BOX 500, BEAVETON, OR, 97077, US

(21) Appl. No.: 11/100,174

(22) Filed: Apr. 5, 2005

Related U.S. Application Data
(60) Provisional application No. 60/562,791, filed on Apr. 16, 2004.

(51) Int. Cl. G06F 19/00

(52) U.S. Cl. 702/79

(57) ABSTRACT

An event occurrence graph for display of events from a monitoring device or set of devices has a time-series of recorded events as a timeline, each event having a separate marker. Different event groups in the time-series occur at different levels, and the markers for the events in each event group may be distinctive from markers for the events in other event groups. Also lines may be drawn connecting start and stop events within an event group. The timeline may be zoomed, and the time scale adjusted automatically accordingly.

### BACKGROUND OF THE INVENTION

The present invention relates to graphic displays, and more particularly to an event occurrence graph display for test and measurement products.

In most products which report the occurrence of an event at a particular time, there is a requirement to visually represent such occurrences. Further there is a requirement to represent such events in relation to each other for analyzing sequences of events. When monitoring several events remotely over a network to which different event generators are coupled, such as MPEG stream testers, waveform monitors and the like in a video situation, it may be desired to see how different alarms created by the different event generators relate to each other. There have been many ways of displaying such event occurrence information, all of which aim at plotting events on a time-series graph. However while plotting complex event occurrence information, these graphs do not adequately represent the relationship and nature of these occurrences in an easy to understand format.

What is desired is an event occurrence display that differentiates between instantaneous event occurrence and “on-off” occurrences; clearly represents the characteristics of the events and state changes in a burst scenario; picks out an event for more details; optimally displays data when the type and count of events generated increases; and shows the progression of events and relationships between events, all in an implementation neutral way which may be used by test and measurement products.

### BRIEF SUMMARY OF THE INVENTION

Accordingly the present invention provides an event occurrence graph for displaying different event types clearly to differentiate between instantaneous events and on/off events. Event generators, such as different types of test instruments that are monitoring a network for different types of events including alarms, are coupled to both an instantaneous event listener and an on-off event listener. When events are generated by the event generators, they are acquired by the respective listeners and input to an event analyzer. The event analyzer records and stores the event information in a data store shared with a display formatter. The stored (history) and new events and their relationships are formatted by the display formatter to present the events as an event occurrence graph for display. The events are presented on a time-series display, but with different event types displayed at different levels and optionally using different event marker shapes and/or color. On-off events are connected by a line to show the “active” period of the on-off event. An operator may “click” on any event or event line and obtain detailed information about the particular instantaneous event or on-off event.

The objects, advantages and other novel features of the present invention are apparent from the following detailed description when read in conjunction with the attached drawing and appended claims.

### BRIEF DESCRIPTION OF THE SEVERAL VIEWS OF THE INVENTION

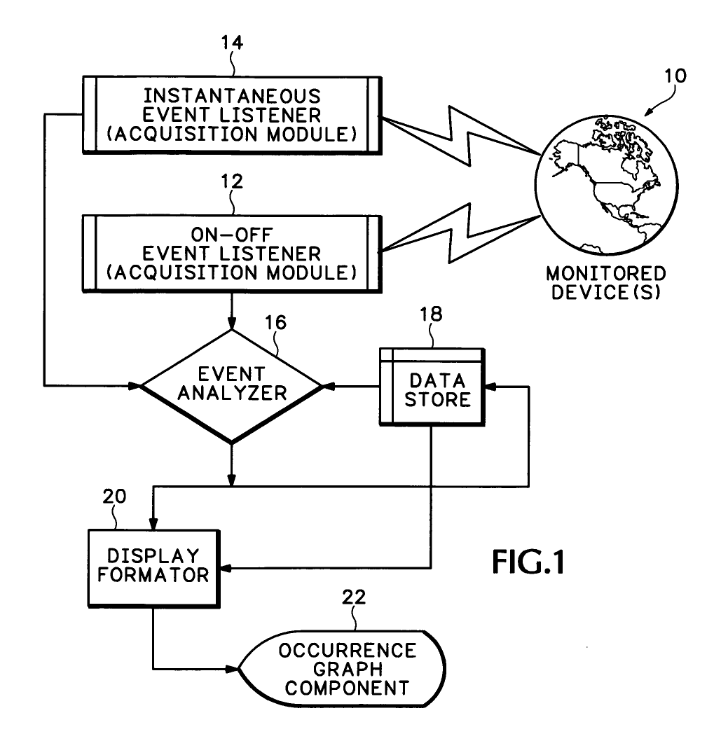

FIG. 1 is a block diagram view of a system for generating an event occurrence graph for display according to the present invention.

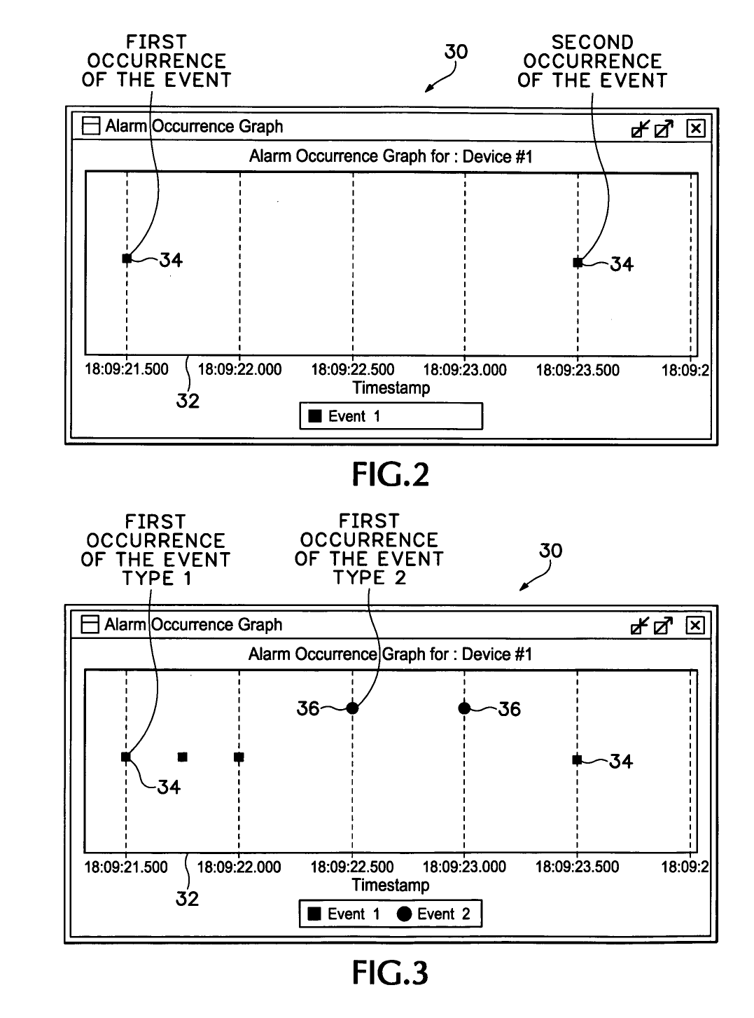

FIG. 2 is a graphic view of a simple event occurrence graph according to the present invention displaying a single event group.

FIG. 3 is a graphic view of an event occurrence graph according to the present invention displaying at least two event groups.

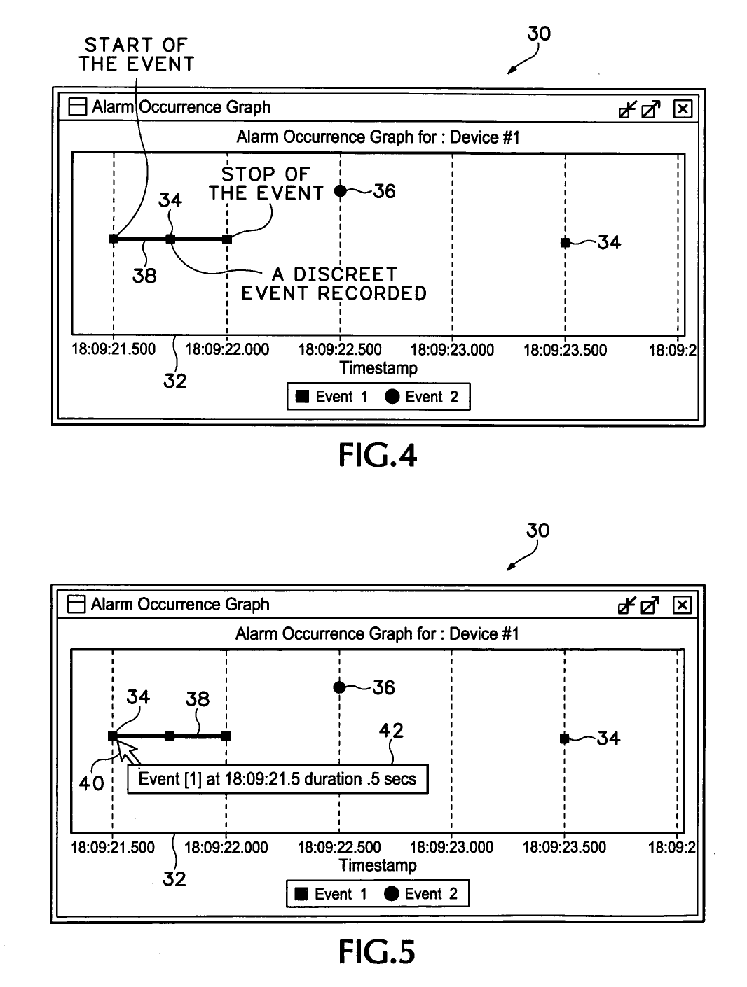

FIG. 4 is a graphic view of an event occurrence graph according to the present invention displaying an on-off event.

FIG. 5 is a graphic view of an event occurrence graph according to the present invention displaying an information window.

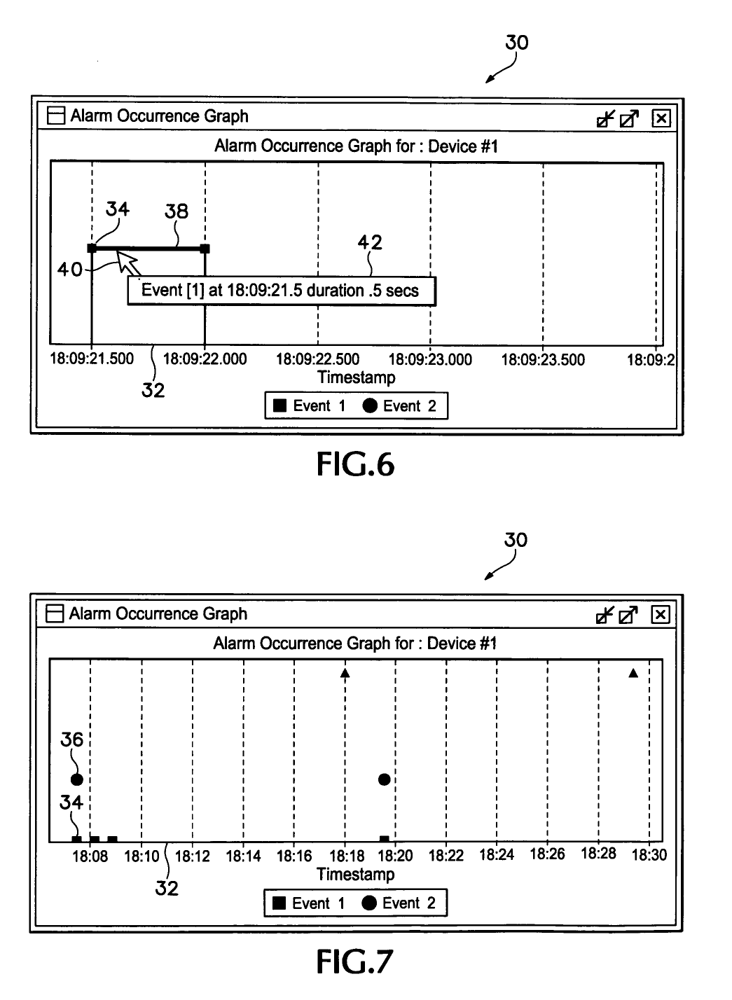

FIG. 6 is a graphic view of an event occurrence graph according to the present invention displaying masking of irrelevant events.

FIG. 7 is a graphic view of an event occurrence graph according to the present invention illustrating automatic time scale adjustment.

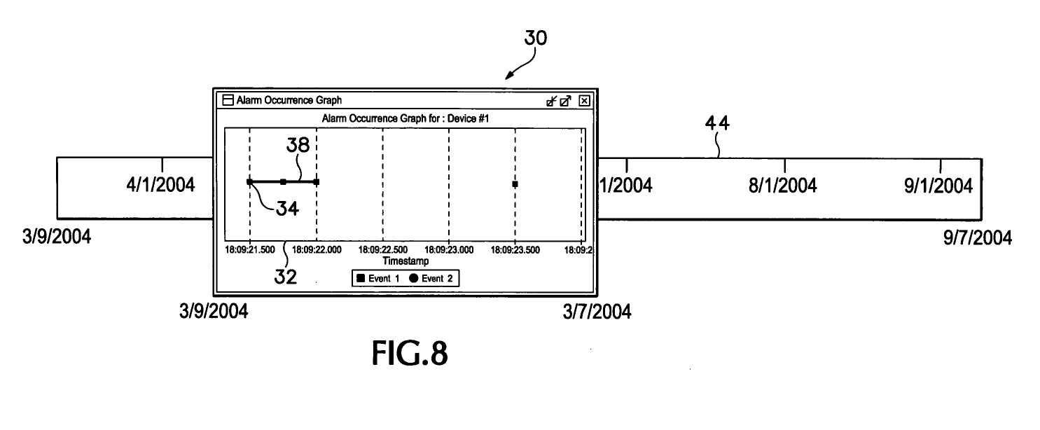

FIG. 8 is a graphic view of an event occurrence graph according to the present invention illustrating zoom of a timeline of events.

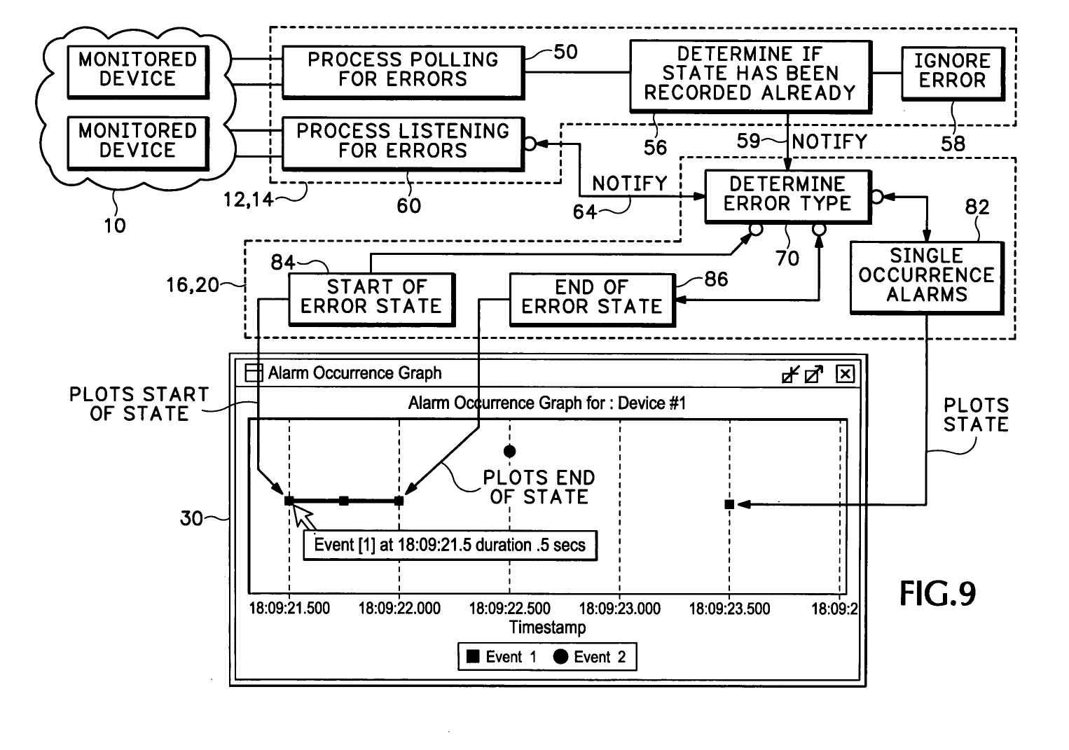

FIG. 9 is a flow diagram view for generating an event occurrence graph for display according to the present invention.

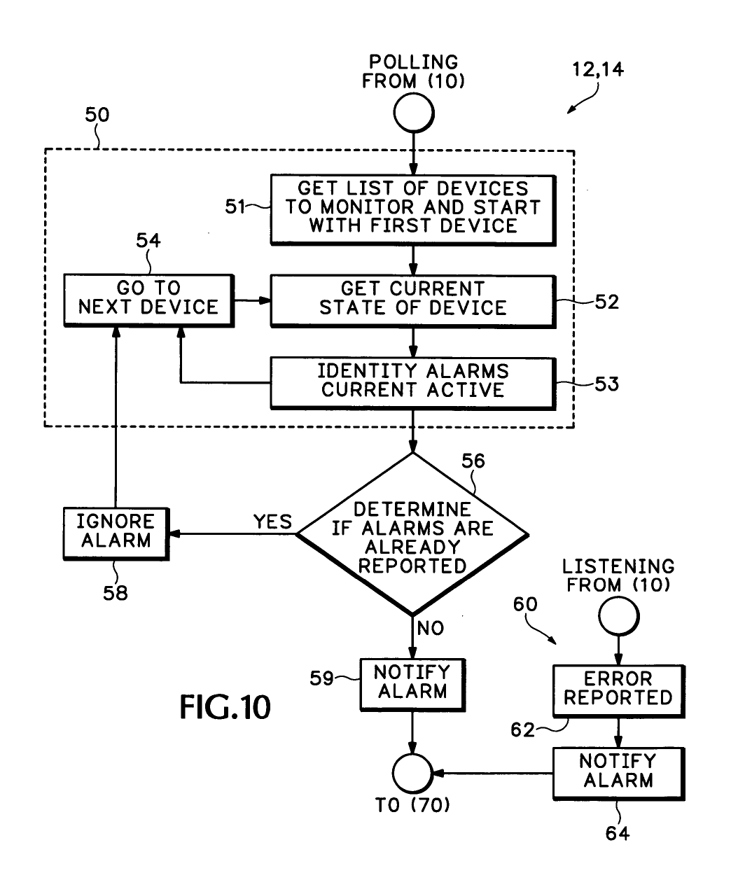

FIG. 10 is a flow diagram view for acquiring events for generating an event occurrence graph for display according to the present invention.

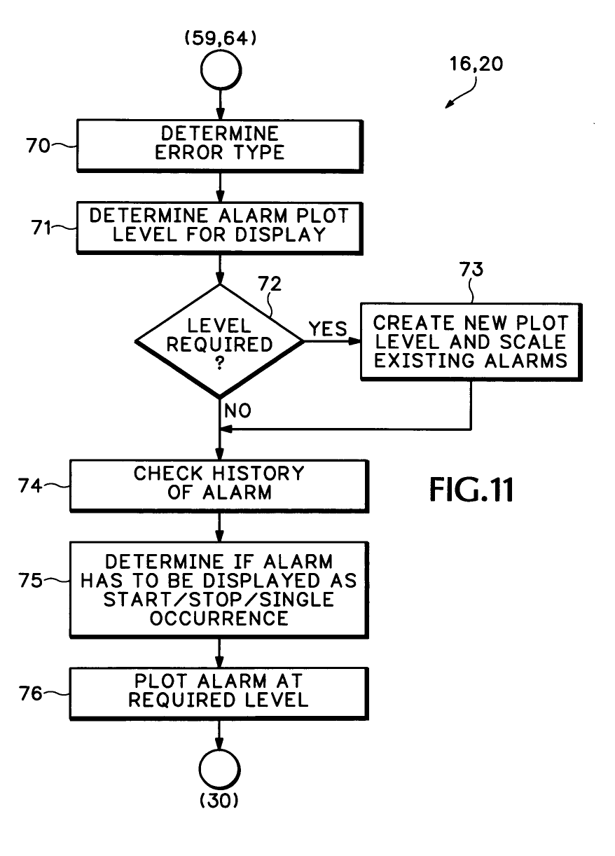

FIG. 11 is a flow diagram view for processing acquired events for generating an event occurrence graph for display according to the present invention.

### DETAILED DESCRIPTION OF THE INVENTION

Referring now to FIG. 1, a monitored device 10 or set of devices, such as different types of video test and measurement devices coupled to a video network for monitoring the video network adherence to applicable standards, are monitored by two acquisition modules 12, 14 at a central location. The first acquisition module 12 records “on-off” events and records the presence or absence of an event. The second acquisition module 14 monitors for intermittent errors that are instantaneous in nature. The data collected from the acquisition modules 12, 14 are transferred to an event analyzer module 16 which records and stores the events in a data store 18. The event analyzer 16 also correlates the “on” to “off” states and determines data that needs to be displayed.

When the event analyzer 16 encounters events that need to be notified to a user, the data from the data store 18 is transferred to a display formatter 20. The display formatter 20 organizes the data in a format that can be displayed on a timeline using an occurrence graph module 22. The display formatter also collects historic data from the data store 18 shared between itself and the event analyzer 16. The display formatter also handles other related functionalities, such as removing old data from the display, etc. When data is transferred to the occurrence graph module 22 from the display formatter 20, the data is plotted according to its display rules.

To provide an event occurrence graph a time-series graph is provided by the occurrence graph module 22 with additional functionalities. As shown in FIG. 2 a time-series event occurrence graph 30 having two dimensions is shown having time along the horizontal axis 32. A particular type of event, designated as Event 1, is shown occurring at two different times using a marker 34, such as a small square as shown and using a particular color if a color display is being used. The event markers 34 are shown at a midway point in the vertical direction.

When a new type of event is recorded, such as Event 2 shown in FIG. 3, a new “level” vertically is allocated for that event. The event marker 36 for Event 2 is shown as a different symbol, i.e., a circle, with a different color if a color display is used. Therefore different levels are allocated for each different type of event or event group. Since the event plotting is based on a timeline, relationships between events are also visually evident, i.e., in this example two events toggling one after the other.

Instantaneous events are shown as individual data points, while “on-off” type events are shown connected with a line 38, as shown in FIG. 4. The connecting line 38 represents the time when the event was recorded in an “active” state. In this instance the event line 38 spans three event markers 34, with the first marker representing the start of the Event and the last marker representing the stop of the Event. The middle marker represents a recorded discrete event.

In order to get addition information on Events, a cursor 40 is kept stationary at an Event marker 34 (as shown in FIG. 5) or an Event marker is “clicked” and an alphanumeric window 42 or “tooltip” is displayed reporting detailed description of the event. In this instance the time of occurrence and the duration of the event is disclosed.

“Clicking” on the duration path or line 38 connecting “on-off” event markers 34 hides all other events on the display and highlights the start and stop time of the event, as shown in FIG. 6. This allows a user to isolate events of interest without having a display cluttered with other events.

As the time scale progresses the graphic display 30 automatically adjusts its scale 32 to allow representation of all the recorded events, as shown in FIG. 7. Zooming in on a particular area of the timeline 44 also changes the scale appropriately, as shown in FIG. 8. Automatic adjustment of the scales allows data to be plotted over extended periods without the need to scroll across the timeline.

The user also may set the time axis, either to a fixed scale starting from the time of the first event to the last event, or scroll across the valid timeline 44. The user also may scroll through a current zoom level across all the data collected using a scrollbar at the bottom of the graphic display. In FIG. 8 the vertical zoom is locked at a fixed level, allowing the user to scroll throughout the timeline 44. This allows the user to walk through the history of events as they occurred.

The user may zoom to any part of the graphic display to allow detailed analysis of the events. All functionalities are similar at all zoom levels.

For further details an overall block diagram of the process is shown in FIG. 9 where the monitored device(s) 10 are polled for errors 50 and/or listened for errors 60. For errors detected during the polling a determination (56) is made as to whether a reported error state has already been recorded. If there is no change in the reported error state, then the error is ignored (58). New error reports are input to a module 70 for characterizing the type of the reported error. The characterization provides an indication of single occurrence alarm 82, the start (“on”) of an error state 84 or the end (“off”) of an error state 86. These alarms are plotted onto a display as the time-series event occurrence graph 30.

More specifically as shown in FIG. 10 the polling process 50 includes getting a list of the devices to monitor (step 51), with polling starting with a first one of the monitored device(s) 10. The next step 52 is to ascertain the current state of the monitored device 10 currently being polled and then to identify (step 53) whether any alarms are currently active. If any alarms are currently active, the state is reported and analyzed 56 to determine if the alarm has already been reported, in which case the alarm is ignored (58). In any event the next monitored device 10 is then polled (step 54) and the process repeated for such next monitored device. The newly active alarm is reported (step 59). The listening process 60 merely receives (step 62) any errors reported by the monitored device(s) 10, and notifies (step 64) of the error.

As shown in FIG. 11 the alarm/error notifications are processed (70) to determine the error type. Then an alarm plot level is determined (step 71) for the display. If a new level is required (step 72), then a new plot level is created and existing alarms are scaled (step 73). In any event the history of the alarm is checked (step 74) and from the history a determination is made (step 75) as to whether the alarm is a single event occurrence or a start/stop event occurrence. The history includes when the alarm first occurred. For the first occurrence of the alarm, it is plotted as a single occurrence 82. However if the alarm state was previously reported and still exists, the alarm is plotted as a continuous event and the first occurrence is changed to the start of error state 84. If the current acquisition no longer includes the alarm event after intervening acquisitions that included the alarm event, then the acquisition is treated as the end of error state 86. The alarm status is then plotted (step 76) as the time-series occurrence graph 30. For video applications typical events may be dropped frames, repeated frames, loss of signal, video out of gamut, etc.

Thus the present invention provides an event occurrence graph for display of events from a monitoring device or set of devices that provides a time-series of events, with different event groups or types of events being displayed at different levels and “on-off” events being connected with a line. The capability to obtain further information about events and to zoom or scroll also is provided.

1. A method of providing an event occurrence graph for display comprising the steps of:
plotting recorded events in the form of markers in a time-series; and
placing the markers for different event groups at different levels along the time-series.

2. The method of claim 1 wherein the markers comprise a unique marker for each event group to further differentiate the event groups.

3. The method of claim 2 wherein the unique marker comprises a unique graphic shape for each event group.

4. The method of claim 3 wherein the unique graphic shape is selected from the group consisting of at least a square, a circle and a triangle.

5. The method as recited in claims 2, 3 or 4 wherein the unique marker for each event group comprises a unique shading.

6. The method as recited in claim 5 wherein the unique shading comprises a unique hue.

7. The method as recited in claim 1 further comprising the step of drawing a line connecting a start event and a stop event within one of the event groups.
